(19) United States
(12) Patent Application Publication
(10) Pub. No.: US 2014/0310359 A1
(43) Pub. Date: Oct. 16, 2014

(54) VEHICLE INFORMATION PROVIDING SYSTEM

(71) Applicant: HYUNDAI MOTOR COMPANY, Seoul (KR)

(72) Inventors: Chul Min Kim, Suwon (KR); Young Su Kim, Yongin (KR); Dong Youl Lee, Seoul (KR); Kwang Chul Jeong, Bucheon (KR)

(73) Assignee: HYUNDAI MOTOR COMPANY, Seoul (KR)

(21) Appl. No.: 14/048,396

(22) Filed: Oct. 8, 2013

(30) Foreign Application Priority Data
Apr. 11, 2013 (KR) 10-2013-0039916

(51) Int. Cl. H04L 29/08

(52) U.S. Cl. CPC H04L 67/125
USPC 709/206

(57) ABSTRACT

A vehicle information providing apparatus provides vehicle information based on a message policy script including a message ID containing data required by each of multiple services, location and length of data in a message, and an interval at which the data is required by each of the services. The apparatus provides messages by filtering the message ID or the interval, or creates and provides a new message containing necessary data only.

### CROSS-REFERENCE TO RELATED APPLICATION

This application claims under 35 U.S.C. §119(a) the benefit of Korean Patent Application No. 10-2013-0039916, filed on Apr. 11, 2013 in the Korean Intellectual Property Office, the disclosure of which is incorporated herein in its entirety by reference.

### BACKGROUND

1. Field of the Invention

The present invention relates to a vehicle information providing system, and more particularly, to a vehicle information providing system in which data required by each of a plurality of services is selected from big data collected as vehicle information.

As provided herein, the term “big data” refers to a collection of data sets that has a large volume, is quickly changed, and may include various data attributes.

2. Description of the Related Art

In general, the electronic system of a vehicle is divided into an electric field system (such as a sensor and a controller) and an information system (such as infotainment and telematics). The vehicle information contains automotive network (CAN, LIN, Flex Ray, MOST) data from the controller and sensor in the electric field system, and contents from an audio, a video, a navigation and/or a telematics unit, and operating information on various types of devices in the information system.

The minimum unit of the vehicle information is a functional signal (e.g., CAN signal) that has a meaning in terms of operation on a creating device (e.g., a controller). Signal data is compressed into hexadecimal form, and is digital data that typically has 1-bit to several-bit length (bit-field).

The vehicle information is transmitted in a transmission unit configured by gathering several signals, and the transmission unit is commonly referred to as a message (e.g., CAN message). Therefore, the vehicle information is transmitted with a message containing several signals. That is, a message contains a plurality of signals corresponding to vehicle information.

The vehicle information is utilized in various applications such as quality of vehicle, new model development, and customized services, each of which requires quite different information. In other words, depending on the purpose, there is a case in which full data about a vehicle is required (e.g., quality inspection), and another case in which only a part of the data is required (e.g., recommendation service).

Accordingly, it would be desirable to provide an arrangement which basically provides a function and performance of transmitting full data about a vehicle to a remote server in real time while selecting only necessary information from the collected full data so as to transmit the information to the remote server outside of the vehicle, depending on a purpose (such as services, applications, and saving communication cost).

### SUMMARY

Accordingly, the present invention has been made to solve the above-mentioned problems occurring in the prior art.

One object to be achieved by the present invention is to provide a policy script managing server that creates a policy script including a message ID containing data required by each service, a location and length of data in a message, and an interval at which data is required by each service.

Further, another object to be achieved by the present invention is to provide a vehicle information providing apparatus that provides, based on a message filtering policy script, filtering messages with message IDs and intervals, or that creates and provides a new message containing required data only.

In one aspect of the present invention, there is provided a policy script managing server, including: a policy script creating unit that creates a policy script based on a service-dependent data list and specification information of a vehicle; and a communication unit that transmits the policy script created by the policy script creating unit to a vehicle information providing apparatus.

In another aspect of the present invention, there is provided a vehicle information providing apparatus, including: a vehicle information message database that stores messages containing vehicle information; a policy script parsing unit that parses a policy script; a message selecting unit that selects messages to be transmitted at a particular interval from the vehicle information message database, based on the policy script parsed by the policy script parsing unit; a message creating unit that extracts data to be transmitted at the particular interval from each of the messages stored in the vehicle information message database, based on the policy script parsed by the policy script parsing unit, and creates a message using the extracted data; a control unit that transmits the messages selected by the message selecting unit to a message providing unit if a total size of the messages does not exceed a protocol overhead, and transmits the message created by the message creating unit if the total size of the messages exceeds the protocol overhead; and the message providing unit providing the messages received from the control unit to each of service servers.

In yet one aspect of the present invention, there is provided a vehicle information providing system, including: a policy script managing server that creates a policy script based on a service-dependent data list and specification information of a vehicle, and transmits the policy script to a vehicle information providing apparatus; and the vehicle information providing apparatus selecting messages to be transmitted at a particular interval from a vehicle message database based on the policy script received from the policy script managing server, and transmitting the selected messages to a service server if a total size of the messages does not exceed a protocol overhead, or creating a message including data to be transmitted at the particular interval to transmit the message to the service server if the total size of the messages exceeds the protocol overhead.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating the configuration of a vehicle information providing system according to an embodiment of the present invention;

FIG. 2 is a block diagram illustrating the configuration of a vehicle information providing apparatus according to an embodiment of the present invention; and

FIG. 3 is a flowchart illustrating the procedure of providing vehicle information according to an embodiment of the present invention.

### DETAILED DESCRIPTION OF THE PREFERRED EMBODIMENTS

Hereinafter, embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

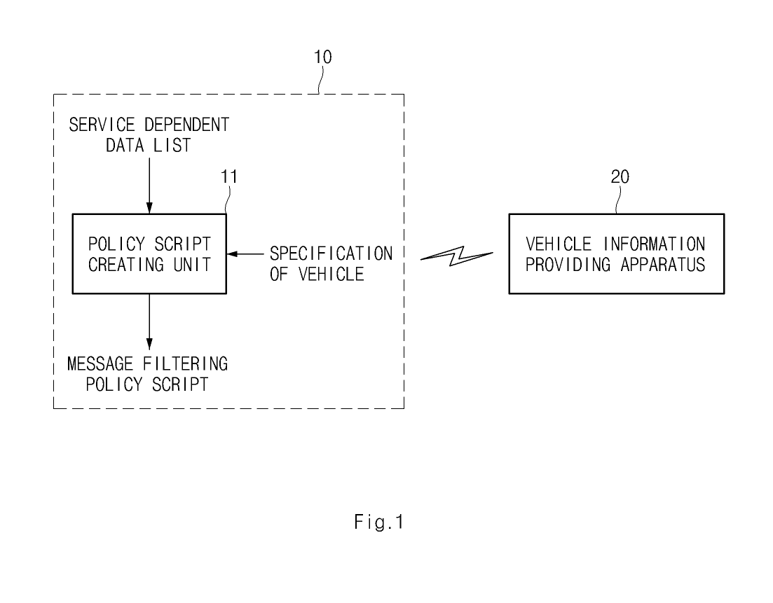

FIG. 1 is a schematic view illustrating the configuration of a vehicle information providing system according to an embodiment of the present invention.

As shown in FIG. 1, the vehicle information providing system includes a policy script managing server 10 and a vehicle information providing apparatus 20.

Preferably, the policy script managing server 10 includes a policy script generating unit 11 that creates a list in which vehicle information required by each service is stored (hereinafter referred to as a service-dependent data list) and creates a message filtering policy script (hereinafter referred to as a policy script) based on specification information of vehicles (e.g., a DBC file), and a communication unit (now shown) that communicates with the vehicle information providing apparatus 10.

The policy script generating unit 11 creates a policy script including a message ID containing data required by each service, location and length of data in a message, and an interval at which data is required by each service.

In particular, the interval at which data is required by each service refers to the interval at which each service requires corresponding data. For example, if speed data is collected at an interval of 1 msec from a vehicle, the collected speed data is stored at an interval of 1 msec. If the speed data is provided at the interval of 1 msec in this case, it merely causes unnecessary network load, and it is an unnecessary task in terms of efficiency since it is not required by the service.

Further, the communication unit transmits the policy script created by the policy script creating unit 11 to the vehicle information providing apparatus 20.

The policy script managing server 10 further includes a communication unit (not shown) to communicate with the vehicle information providing apparatus 20. The communication unit remotely transmits the policy script created by the policy script creating unit 11 to a vehicle. The remote transmission manner may be a Data Push manner such that the policy script managing server 10 transmits the policy script to the vehicle information providing apparatus 20, or a periodic polling manner such that the vehicle information providing apparatus 20 obtains the policy script from the policy script managing server 10.

Then, the vehicle information providing apparatus 20 may select and provide vehicle information necessary for each service based on the policy script transmitted from the policy script managing server 10. In particular, the vehicle information providing apparatus 20 detects a message containing service-dependent data at a corresponding interval based on the policy script, and determines the location and length of the data in the detected message.

Further, the vehicle information providing apparatus 20 provides vehicle information required by each service according to the following three arrangements:

First, a message ID filtering scheme. Transmitting detected messages as they are (Bypass) if the size of a message to be transmitted at an interval does not exceed a protocol overhead.

Second, data (signal) filtering scheme. Extracting data from each of messages required by a service, creating a new message, and transmitting the new message.

Third, a periodic filtering scheme. Transmitting a counting information (value) if a message (or data) to be transmitted is identical to the message (or data) transmitted at the immediately previous interval.

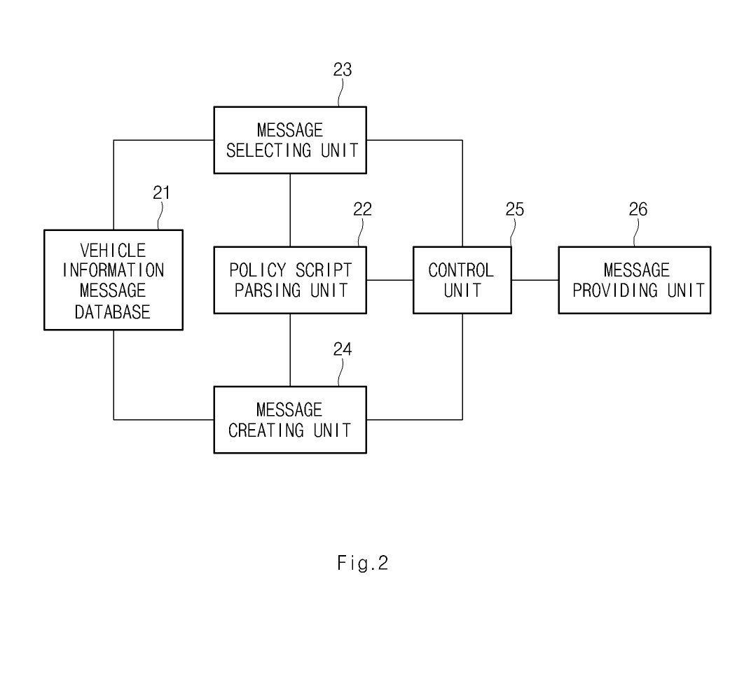

FIG. 2 is a block diagram illustrating the configuration of a vehicle information providing system according to an embodiment of the present invention.

As shown in FIG. 2, the vehicle information providing apparatus according to the embodiment of the present invention includes a vehicle information message database 21, a policy script parsing unit 22, a message selecting unit 23, a message creating unit 24, a control unit 25 and a message providing unit 26.

Specifically, the vehicle information message database 21 stores a message containing vehicle information therein. Here, the vehicle information is collected through automotive networks such as a controller area network (CAN), a local interconnect network (LIN), a Flex Ray, and a media oriented systems transport (Most). In addition, the vehicle information is big data that contains contents from an audio, a video, a navigation and/or a telematics unit, and operating information on various types of devices.

The policy script parsing unit 22 parses the policy script transmitted from the policy script managing server 10. Specifically, for message filtering, the policy script parsing unit 22 acquires message IDs containing data required by each service, the location and length of data in a message, and intervals at which data is required for each service.

The message selecting unit 23 is driven under the control of the control unit 25, and selects messages to be transmitted at an interval from the vehicle information message database 21 based on the policy script parsed by the policy script parsing unit 22.

The message creating unit 24 is driven under the control of the control unit 25, and extracts data to be transmitted at an interval from each message stored in the vehicle information message database to create a new messages using the extracted data, based on the policy script parsed by the policy script parsing unit 22. In particular, the message creating unit 24 creates a message consisting only of data required by the service at the particular interval.

The control unit 25 compares the total size of the messages selected by the message selecting unit 23 with a protocol overhead, and transmits the messages selected by the message selecting unit 23 to the message providing unit 26 of the total size of the messages does not exceed the protocol overhead, and drives the message creating unit 24 otherwise.

Then, the control unit 25 transmits the message created by the message creating unit 24 to the message providing unit 26. In addition, the control unit 25 transmits a counting information (value) to the message providing unit 26 if a message (or data) to be transmitted at a particular interval is identical to the message (or data) transmitted at the immediately previous interval. Next, the message providing unit 26 provides the message or counting information transmitted from the control unit to a corresponding service providing server (not shown).

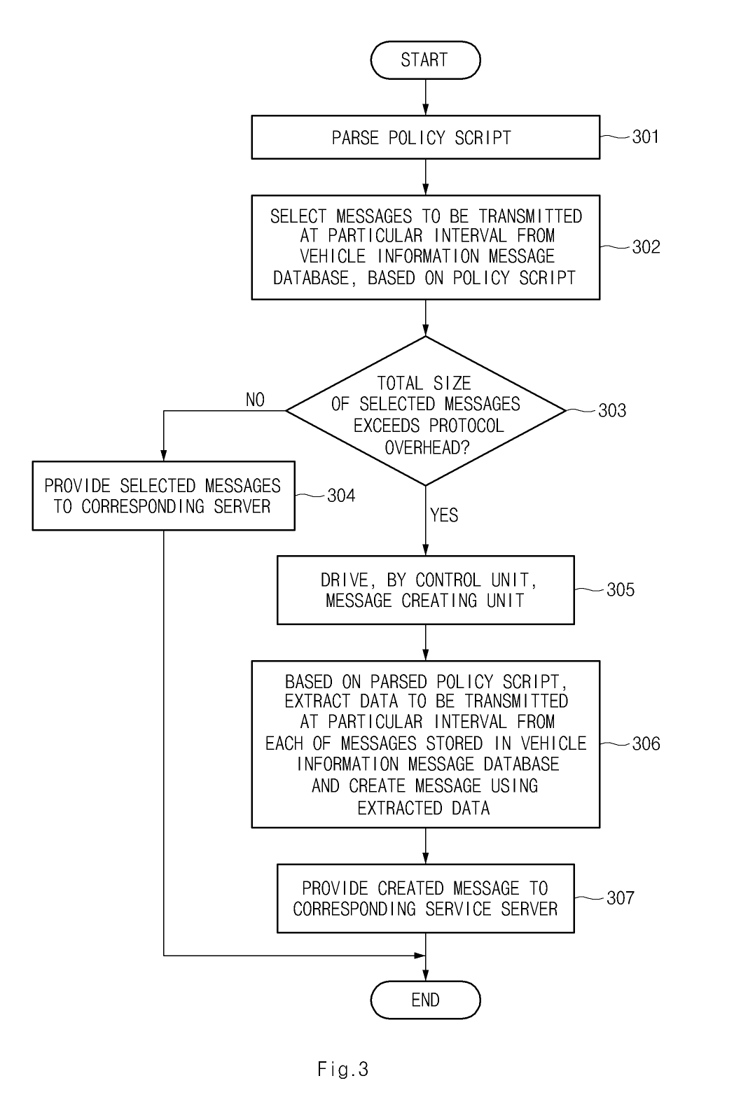

FIG. 3 is a flowchart illustrating the procedure of providing vehicle information according to an embodiment of the present invention.

Initially, a policy script parsing unit 22 parses a policy script (step 301). The message selecting unit 23 selects messages to be transmitted at a particular interval from a vehicle information message database 21 based on the policy script parsed by the policy script parsing unit 22 (step 302). Then, the control unit 25 compares the total size of the messages selected by a message selecting unit 23 with a protocol overhead (step 303).

If the comparison result indicates that the total size does not exceed the protocol overhead (step 303), the message providing unit 26 provides the selected messages to a corresponding service server (step 304). If the comparison result indicates that the total size exceeds the protocol overhead (step 303), the control unit 25 drives the message creating unit 24 (step 305).

The message creating unit 24 extracts data to be transmitted at a particular interval from each message stored in the vehicle information message database 21 to create a message using the extracted data, based on the policy script parsed by the policy script parsing unit 22 (step 306). Then, the message providing unit 24 provides the message created by the message creating unit 24 to the corresponding service server under the control of the control unit 25 (step 307).

As set forth above, according to the embodiment of the present invention, the vehicle information providing apparatus provides vehicle information based on a message policy script including a message ID containing data required by each of services, a location and length of data in a message, and an interval at which data is required by each of the services, by filtering with the message ID or the interval, or creating and providing a new message containing necessary data only. Accordingly, a service provider transmits only vehicle information required by a service user, thereby saving network usage cost.

What is claimed is:

1. A vehicle information providing apparatus, comprising:
a vehicle information message database storing messages containing vehicle information;
a policy script parsing unit that parses a policy script;
a message selecting unit that selects messages to be transmitted at a particular interval from the vehicle information message database, based on the policy script parsed by the policy script parsing unit;
a message creating unit that extracts data to be transmitted at the particular interval from each of the messages stored in the vehicle information message database, based on the policy script parsed by the policy script parsing unit, and creates a message using the extracted data;
a control unit that transmits each of the messages selected by the message selecting unit to a message providing unit if a total size of the messages does not exceed a protocol overhead, and transmits the message created by the message creating unit if the total size of the messages exceeds the protocol overhead; and
the message providing unit that provides the messages received from the control unit to each of a plurality of service servers.

2. The apparatus according to claim 1, wherein the control unit drives the message creating unit if the total size of the messages selected by the message selecting unit exceeds the protocol overhead.

3. The apparatus according to claim 1, wherein the control unit transmits counting information to the message providing unit if a message to be transmitted at a particular interval is identical to a message transmitted immediately before.

4. The apparatus according to claim 3, wherein the message providing unit is further configured to provide the counting information to a corresponding service server.

5. The apparatus according to claim 1, wherein the policy script includes at least one of a message ID containing data required by each of a plurality of services, a location and length of data in the message, and an interval at which each of the services require data.

6. A policy script managing server, comprising:
a policy script creating unit that creates a policy script based on a service-dependent data list and specification information of a vehicle; and
a communication unit that transmits the policy script created by the policy script creating unit to a vehicle information providing apparatus.

7. The policy script managing server according to claim 6, wherein the policy script includes at least one of a message ID containing data required by each of a plurality of services, a location and length of data in a message, and an interval at which each of the services require data.

8. A vehicle information providing system, comprising:
a policy script managing server that creates a policy script based on a service-dependent data list and specification information of a vehicle, and transmits the policy script to a vehicle information providing apparatus; and
the vehicle information providing apparatus selecting messages to be transmitted at a particular interval from a vehicle message database based on the policy script received from the policy script managing server, and transmitting the selected messages to a service server if a total size of the messages does not exceed a protocol overhead, or creating a message including data to be transmitted at the particular interval to transmit the message to the service server if the total size of the messages exceeds the protocol overhead.

9. The system according to claim 8, wherein the vehicle information providing apparatus includes:
a vehicle information message database that stores messages containing vehicle information;
a policy script parsing unit that parses a policy script;
a message selecting unit that selects messages to be transmitted at a particular interval from the vehicle information message database, based on the policy script parsed by the policy script parsing unit;
a message creating unit that extracts data to be transmitted at the particular interval from each of the messages stored in the vehicle information message database, based on the policy script parsed by the policy script parsing unit, and creates a message using the extracted data;
a control unit that transmits the messages selected by the message selecting unit to a message providing unit if a total size of the messages does not exceed a protocol overhead, and transmits the message created by the message creating unit if the total size of the messages exceeds the protocol overhead; and
the message providing unit providing the messages received from the control unit to each of a plurality of service servers.

10. The system according to claim 9, wherein the control unit drives the message creating unit if the total size of the messages selected by the message selecting unit exceeds the protocol overhead.

11. The system according to claim 9, wherein the control unit transmits counting information to the message providing unit if a message to be transmitted at a particular interval is identical to a message transmitted immediately before.

12. The system according to claim 11, wherein the message providing unit is further configured to provide the counting information to a corresponding service server.

13. The system according to claim 9, wherein the policy script includes at least one of a message ID containing data required by each of a plurality of services, a location and length of data in a message, and an interval at which each of the services require data.
